(19) United States
(12) Patent Application Publication
(10) Pub. No.: US 2010/0084923 A1
(43) Pub. Date: Apr. 8, 2010

(54) FUEL CELL SYSTEM

(76) Inventors: Michio Yoshida, Aichi (JP); Tadaichi Matsumoto, Aichi (JP)

Correspondence Address: KENYON & KENYON LLP, 1500 K STREET N.W., SUITE 700, WASHINGTON, DC, 20005, US

(21) Appl. No.: 12/530,931

(22) PCT Filed: Mar. 10, 2008
(86) PCT No.: PCT/JP2008/054828

§ 371 Date: Sep. 11, 2009

(30) Foreign Application Priority Data
Mar. 12, 2007 (JP) 2007-061842

(51) Int. Cl. H02J 4/00

(52) U.S. Cl. 307/80

(57) ABSTRACT

To provide a fuel cell system capable of efficiently transmitting electric power output from a battery to a load. A control unit 80 turns a relay 20 off so as to cut off the connection between a fuel cell 40 and an inverter 50 if it is determined that a command indicating that an EV travel mode should be set has been received. Then, the control unit 80 detects an output voltage of the battery 60 on the basis of SOC information supplied from a SOC sensor 65. Further, based on the detected output voltage of the battery 60, the control unit 80 determines an optimum operating voltage at the point of time by taking converter efficiency and inverter efficiency into account.

### TECHNICAL FIELD

The present invention relates to a fuel cell system.

### BACKGROUND ART

There has been known a fuel cell system which generates electric power by utilizing the electrochemical reaction between a fuel gas, which includes hydrogen, and an oxidizing gas, which includes oxygen. Such a fuel cell system is a highly efficient, clean electric power generating means, thus offering great promise as a driving power source for a two-wheel vehicle, an automobile and the like.

The responsiveness of output electric power of the fuel cell occasionally deteriorates. As a means for preventing such a drawback, therefore, a technique whereby a fuel cell and a battery are connected in parallel to constitute a power supply has been proposed. For example, Patent Document 1 given below discloses a construction in which a load, such as a traction motor, is connected to a fuel cell through the intermediary of an inverter, and a battery is connected in parallel to the fuel cell through the intermediary of a DC/DC converter.

### [Patent Document 1] Japanese Patent Application Laid-Open No. 2002-118981

### DISCLOSURE OF INVENTION

However, according to the aforementioned construction, even when a load is driven using only the battery in an EV travel mode or the like, the output voltage of the DC/DC converter (i.e., the operating voltage of the system) is controlled so as to always set the inverter to maximum efficiency, giving no consideration to the efficiency of the DC/DC converter. This has hardly been implementing most efficient transmission of the electric power output from the battery to the load.

The present invention has been made in view of the circumstances described above, and it is an object of the invention to provide a fuel cell system capable of efficiently transmitting the electric power output from an electric storage device, such as a battery, to a load.

To solve the aforesaid problem, a fuel cell system in accordance with the present invention comprises a fuel cell, a voltage converting device, an electric storage device connected in parallel to the fuel cell through the intermediary of the voltage converting device, an electric power converting device which converts a DC electric power output from at least the fuel cell or the electric storage device into an AC electric power and supplies the AC electric power to a load, and determining means which determines an operating voltage of the system on the basis of voltage conversion efficiency of the voltage converting device and electric power conversion efficiency of the electric power converting device.

This arrangement considers not only the efficiency of the electric power conversion by an electric power converting device (e.g., an inverter) but also the efficiency of the voltage conversion by a voltage converting device (e.g., a DC/DC converter) to determine the operating voltage of the system, thus allowing the electric power output from an electric storage device (a battery or the like) to be efficiently voltage to a load.

Here, in the aforesaid construction, the determining means is preferably further provided with voltage conversion control means which determines the operating voltage of the system in the case where a command for setting only the electric storage device as the electric power supply is received, and controls a voltage converting operation by the voltage converting device according to the determined operating voltage.

Further preferably, the aforesaid construction further includes a sensor for detecting the state of electricity storage of the electric storage device, and the determining means determines the operating voltage of the system on the basis of the detected state of electricity storage of the electric storage device, the voltage conversion efficiency of the voltage converting device, and the electric power conversion efficiency of the electric power converting device.

Further, the aforesaid construction preferably further includes a switching element inserted in a path for connection between the fuel cell and the electric power converting device, and switching control means which cuts off the electrical connection between the fuel cell and the electric power converting device by the switching element in the case where the command for setting only the electric storage device as the electric power supply is received.

As described above, the present invention permits efficient transmission of the electric power output from an electric storage device, such as a battery, to a load.

### BRIEF DESCRIPTION OF THE DRAWINGS

FIG. 1 is a diagram illustrating the construction of a fuel cell system according to a present embodiment.

FIG. 2 is a diagram illustrating a relationship between operating voltages and the efficiency of an inverter.

FIG. 3 is a diagram illustrating a relationship between input/output voltage difference and the efficiency of a converter.

FIG. 4 is a diagram for explaining a method for determining an operating voltage in an EV travel mode according to a prior art.

FIG. 5 is a diagram for explaining a method for determining an operating voltage in an EV travel mode according to the present invention.

FIG. 6 is a flowchart illustrating travel control processing.

### BEST MODE FOR CARRYING OUT THE INVENTION

The following will describe an embodiment according to the present invention with reference to the accompanying drawings.

### A. Present Embodiment

### (1) Construction of the Embodiment

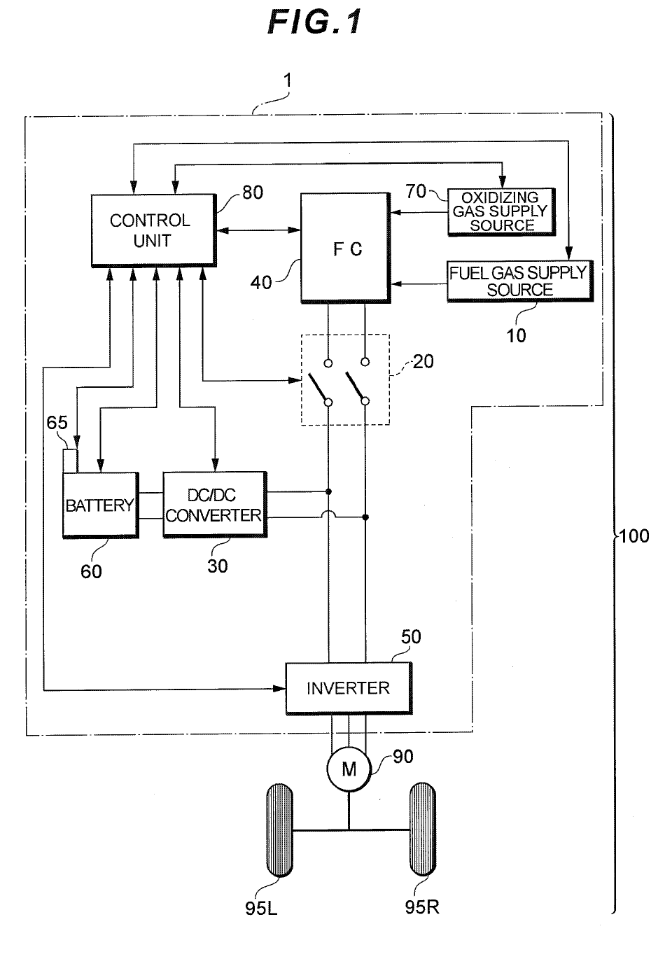

FIG. 1 illustrates the schematic construction of a vehicle provided with a fuel cell system 100 in accordance with the present embodiment.

In the following description, a fuel cell hybrid vehicle (FCHV) will be taken as an example of a vehicle; however, the fuel cell system 100 is applicable also to an electric vehicle or a hybrid vehicle. Further, the fuel cell system 100 can be applied also to a variety of mobile bodies (e.g., a marine vessel, an airplane, and a robot) in addition to a vehicle.

The vehicle travels using a traction motor 90, which is connected to wheels 95L and 95R, as a driving force source. The power supply of the traction motor 90 is a power supply system 1. A direct current output from the power supply system 1 is converted into a three-phase alternating current by an inverter 50 before being supplied to the traction motor 90. The traction motor 90 is capable of functioning also as an electric power generator in a braking mode.

The power supply system 1 is constructed mainly of a fuel cell 40, a battery 60, a DC/DC converter 30, and the inverter 50.

The fuel cell 40 is a means which generates electric power from supplied reactant gases (a fuel gas and an oxidizing gas), and may use various types of fuel cells, including a solid polymer type, a phosphoric-acid type, and a molten carbonate type. The fuel cell 40 has a stack structure formed by stacking in series a plurality of single cells provided with MEAs or the like. An output voltage (hereinafter referred to as “the FC voltage”) and an output current (hereinafter referred to as “the FC current”) of the fuel cell 40 are detected by a voltage sensor and a current sensor (both sensors not being shown), respectively. A fuel gas supply source 10 supplies a fuel gas, such as a hydrogen gas, to a fuel electrode (anode) of the fuel cell 40, while an oxidizing gas supply source 70 supplies an oxidizing gas, such as air, to an oxygen electrode (cathode).

The fuel gas supply source 10 consists of, for example, a hydrogen tank and various valves and the like, and adjusts the opening degrees of the valves and the ON/OFF time or the like, thereby controlling the amount of a fuel gas supplied to the fuel cell 40.

The oxidizing gas supply source 70 is constituted of, for example, an air compressor, a motor for driving the air compressor, an inverter and the like, and adjusts mainly the revolution speed of the motor so as to adjust the amount of an oxidizing gas supplied to the fuel cell 40.

The battery (electric storage device) 60 is a secondary cell which is chargeable/dischargeable and constituted of, for example, a nickel hydride battery or the like. Of course, in place of the battery 60, a chargeable/dischargeable electric condenser (e.g., a capacitor) other than the secondary cell may be provided. The battery 60 is connected in parallel to the fuel cell 40 through the intermediary of the DC/DC converter 30. The battery 60 is provided with a SOC sensor (sensor) 65 which detects the state of charge of the battery. The SOC sensor 65 detects the state of charge of the battery 60 according to an instruction given from a control unit 80 and outputs the result of the detection as SOC information to the control unit 80.

The DC/DC converter (voltage converting device) 30 is a full-bridge converter composed of, for example, four power transistors and a dedicated drive circuit (none of these being shown). The DC/DC converter 30 has a function for increasing or decreasing a DC voltage input from the battery 60 and outputting the increased or decreased DC voltage to the inverter 50, and a function for increasing or decreasing a DC voltage input from the fuel cell 40 or the traction motor 90 and outputting the increased or decreased DC voltage to the battery 60. The charge/discharge of the battery 60 is implemented by the functions of the DC/DC converter 30. Incidentally, auxiliary equipment, such as vehicular auxiliary equipment (e.g., lighting equipment) and FC auxiliary equipment (e.g., a pump for a fuel gas), is connected between the battery 60 and the DC/DC converter 30.

The inverter (electric power converting device) 50 is, for example, a PWM inverter using the pulse width modulation method, and converts a DC electric power output from the fuel cell 40 or the battery 60 into a three-phase AC electric power according to a control command given from the control unit 80 and supplies the converted three-phase AC electric power to the traction motor 90. A relay (switching element) 20 is inserted between the inverter 50 and the fuel cell 40. The control unit (the switching control means) 80 switches the relay 20 between ON and OFF thereby to control the connection and disconnection between the inverter 50 and the fuel cell 40.

The traction motor (load) 90 is a motor (i.e., a motive power source for a mobile body) for driving the wheels 95L and 95R, the revolution speed of the motor being controlled by the inverter 50. In the present embodiment, the traction motor 90 has been illustrated as the load connected to the inverter 50; however, the load is not limited thereto. The present invention is applicable to any type of electronic equipment (load).

The control unit 80 includes a CPU, a ROM, a RAM and the like, and centrically controls each section of the system on the basis of sensor signals input from the SOC sensor 65, a voltage sensor and a current sensor which detect an output voltage and an output current of the fuel cell 40, an accelerator (gas) pedal and the like.

Further, in an EV travel mode, the control unit (the determining means) 80 determines the operating point (=operating voltage) of the system on the basis of the electric power conversion efficiency of the inverter 50 (hereinafter referred to as “the inverter efficiency”) and the voltage conversion efficiency of the DC/DC converter 30 (hereinafter referred to as “the converter efficiency”) such that the efficiency of the fuel cell system 100 will be optimum. Then, the control unit (the voltage conversion control means) 80 controls the operation of the DC/DC converter 30 such that the output voltage of the DC/DC converter 30 coincides with the determined operating voltage. Thus, determining the operating voltage by considering not only the inverter efficiency but also the converter efficiency makes it possible to efficiently transmit the electric power output from the battery 60 to a load. The reason for this will be described below.

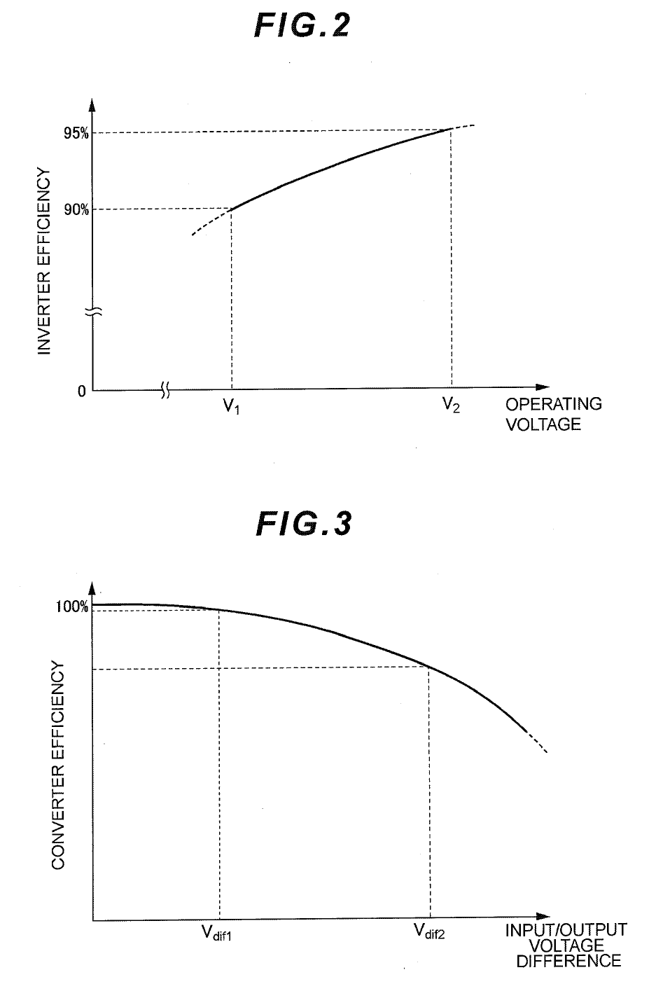

FIG. 2 is a diagram illustrating the relationship between the operating voltage and the inverter efficiency, and FIG. 3 is a diagram illustrating the relationship between input/output voltage difference and the converter efficiency. Incidentally, the input/output voltage difference shown in FIG. 3 refers to a voltage difference between an input voltage and an output voltage of the DC/DC converter 30.

As illustrated in FIG. 2, the inverter efficiency increases as the set operating voltage increases (refer to operating voltages V1 and V2 given in FIG. 2). In contrast thereto, the converter efficiency decreases as the input/output voltage difference increases, as illustrated in FIG. 3 (refer to input/output voltage differences Vdif1 and Vdif2 shown in FIG. 3).

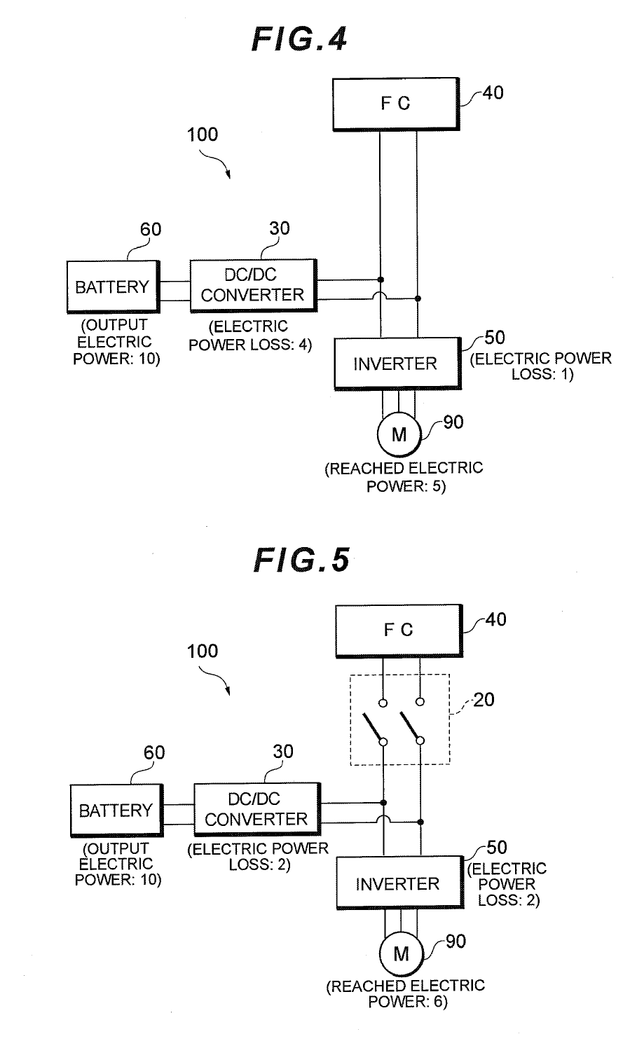

Here, FIG. 4 and FIG. 5 are diagrams for describing the method for determining the operating voltage in the EV travel mode. FIG. 4 illustrates the construction according to a prior art, and FIG. 5 illustrates the construction according to the present embodiment. Regarding the fuel cell system illustrated in FIG. 4 and FIG. 5, the components corresponding to those shown in FIG. 1 will be assigned like reference numerals and detailed description thereof will be omitted.

As illustrated in FIG. 4 and FIG. 5, the output electric power of the battery 60 is supplied to the inverter 50 through the intermediary of the DC/DC converter 30 in the EV travel mode.

According to the prior art, only the inverter efficiency has been taken into account to determine the operating voltage, so that the output electric power of the battery 60 has not always been transmitted to the traction motor 90 with highest possible efficiency. To be more specific, as illustrated in FIG. 2, the inverter efficiency increases as the set operating voltage increases, so that the operating voltage has conventionally been set in the vicinity of an OCV (Open Circuit Voltage) of the fuel cell 40 (e.g., 400V). However, the converter efficiency decreases as the input/output voltage difference of the DC/DC converter 30 increases, as illustrated in FIG. 3. From the viewpoint of the converter efficiency, the input/output voltage of the DC/DC converter 30 is preferably small as much as possible. However, if the operating voltage is determined by taking only the inverter efficiency into account, there has been a case where the electric power loss at the DC/DC converter 30 undesirably becomes large (the electric power loss in FIG. 4 is “4”), while the electric power loss at the inverter 50 becomes small (the electric power loss in FIG. 4 is “1”), as illustrated in FIG. 4, resulting in lower system efficiency (=reached electric power/output electric power) in the end (reached electric power in FIG. 4 is “5”).

In contrast thereto, according to the present embodiment, the operating voltage is determined by considering not only the inverter efficiency but also the converter efficiency. As a result, as illustrated in FIG. 5, the electric power loss at the DC/DC converter 30 becomes smaller than that in the prior art (the electric power loss in FIG. 5 is “2”) although the electric power loss at the inverter 50 is larger than that in the prior art (the electric power loss in FIG. 5 is “2”), thus permitting improved system efficiency in the end (the reached electric power in FIG. 5 is “6”). If the determined operating voltage is lower (e.g., 350V) than the neighborhood of the OCV of the fuel cell 40 (e.g., 400V), then there is a danger in that the fuel cell 40 will generate electric power due to the influences of a residual gas if the fuel cell 40 and the inverter 50 are left connected (refer to FIG. 4), causing the operating voltage to rise. According to the present embodiment, therefore, the relay 20 is provided between the fuel cell 40 and the inverter 50 so as to prevent unnecessary electric power generation of the fuel cell 40 by turning the relay 20 off.

The following will describe the operation of the present embodiment.

### (2) Operation of the Embodiment

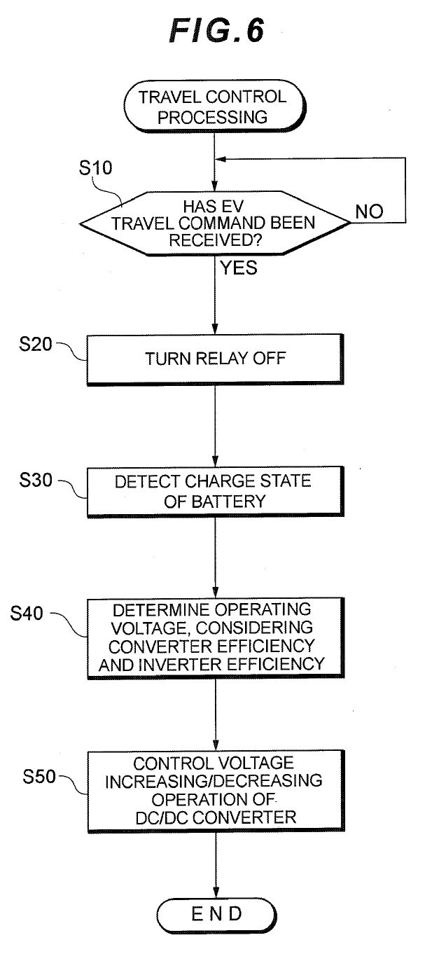

FIG. 6 is a flowchart illustrating the travel control processing intermittently carried out by the control unit 80.

Based on sensor signals input from various sensors and the like, the control unit 80 determines whether a command indicating that the EV travel mode should be set (a command indicating that only the battery 60 should be the electric power supply) has been received (step S10). If the control unit 80 determines that the command has been received (YES in step S10), then the control unit 80 turns the relay 20 off to cut off the connection between the fuel cell 40 and the inverter 50 (step S20). Then, the control unit 80 detects the state of charge (output voltage) of the battery 60 at that point of time on the basis of the SOC information supplied from the SOC sensor 65 (step S30). As widely known, the output voltage of the battery 60 changes every second according to the use situations (e.g., operating time). The optimum operating voltage changes according to the output voltage of the battery 60, so that the charge state (output voltage) of the battery 60 at that point of time is detected in this case.

Then, the control unit 80 determines the operating voltage optimum (i.e., providing highest system efficiency) at that point of time, considering the converter efficiency and the inverter efficiency on the basis of a detected output voltage of the battery 60 (step S40). Based on the operating voltage determined as described above, the control unit 80 controls the operation of increasing or decreasing the voltage of the DC/DC converter 30 (step S50). Carrying out the series of processing described above permits efficient transmission of the electric power output from the battery 60 to a load.

### B. Modification Examples

### First Modification Example

In the present embodiment described above, the relay 20 is provided between the fuel cell 40 and the inverter 50, and the relay 20 is turned off in the EV travel mode to prevent unnecessary electric power generation of the fuel cell 40. However, any other method may be adopted as long as the method permits the prevention of the electric power generation.

### Second Modification Example

In the present embodiment, the case where only the battery 60 is used as the electric power supply (the EV travel mode) has been described; however, the present invention is applicable also to a case where the battery 60 and another electric power source (including the fuel cell 40) are used as the electric power supply.

1. (canceled)

2. A fuel cell system comprising:
a fuel cell;
a voltage converting device;
an electric storage device connected in parallel to the fuel cell through the intermediary of the voltage converting device;
an electric power converting device which converts a DC electric power output from at least the fuel cell or the electric storage device into an AC electric power and supplies the AC electric power to a load;
a determining device which determines an operating voltage of the system; and
a voltage conversion control device which controls a voltage converting operation by the voltage converting device according to a determined operating voltage,
wherein the determining device determines the operating voltage of the system on the basis of voltage conversion efficiency of the voltage converting device and electric power conversion efficiency of the electric power converting device in the case where a command indicating that only the electric storage device should be an electric power supply is received, whereas the determining device determines the operating voltage of the system on the basis of only the electric power conversion efficiency of the electric power converting device in the case where the command indicating that only the electric storage device should be the electric power supply is not received.

3. The fuel cell system according to claim 2, further comprising a sensor for detecting the state of electricity storage of the electric storage device,
wherein the determining device determines the operating voltage of the system on the basis of the detected state of electricity storage of the electric storage device, the voltage conversion efficiency of the voltage converting device, and the electric power conversion efficiency of the electric power converting device in the case where the command indicating that only the electric storage device should be an electric power supply is received.

4. The fuel cell system according to claim 3, further comprising:
a switching element inserted in a path for connection between the fuel cell and the electric power converting device; and
a switching control which cuts off the electrical connection between the fuel cell and the electric power converting device by the switching element in the case where the command for setting only the electric storage device as the electric power supply is received.
